(19) United States
(12) Patent Application Publication
(10) Pub. No.: US 2010/0009144 A1
(43) Pub. Date: Jan. 14, 2010

(54) Two-Level Layer Thermal Protection System With Pyrochlore Phase

(76) Inventors: Eckart Schumann, Mulheim an der Ruhr (DE); Ramesh Subramanian, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/084,304

(22) PCT Filed: Oct. 13, 2006
(86) PCT No.: PCT/EP2006/067370

§ 371 Date: Aug. 21, 2009

(30) Foreign Application Priority Data
Nov. 4, 2005 (EP) 050241140

(51) Int. Cl. B32B 9/00

(52) U.S. Cl. 428/213; 428/472; 428/335; 428/332

(57) ABSTRACT

In addition to good thermal barrier properties, thermal barrier coating systems also have to have a long thermal barrier coating service life. The coating system according to the invention comprises a specially adapted layer sequence made up of metallic bonding layer, which consists of an NiCoCrAlX, inner ceramic layer and outer ceramic layer, at least 80% of which is made up of the pyrochlore phase Gd₂Zr₂O₇ or Gd₂Hf₂O₇.

### CROSS REFERENCE TO RELATED APPLICATIONS

This application is the US National Stage of International Application No. PCT/EP2006/067370, filed Oct. 13, 2006 and claims the benefit thereof. The International Application claims the benefits of European application No. 05024114.0 filed Nov. 4, 2005, both of the applications are incorporated by reference herein in their entirety.

### FIELD OF INVENTION

The invention relates to a layer system with pyrochlores as claimed in the claims.

### BACKGROUND OF THE INVENTION

Such a layer system has a substrate comprising a metal alloy based on nickel or cobalt. Such products are used especially as a component of a gas turbine, in particular as gas turbine blades or heat shields. The components are exposed to a hot gas flow of aggressive combustion gases. They must therefore be able to withstand heavy thermal loads. It is furthermore necessary for these components to be oxidation- and corrosion-resistant. Especially moving components, for example gas turbine blades, but also static components, are furthermore subject to mechanical requirements. The power and efficiency of a gas turbine, in which there are components exposable to hot gas, increase with a rising operating temperature. In order to achieve a high efficiency and a high power, those gas turbine components which are particularly exposed to high temperatures are coated with a ceramic material. This acts as a thermal insulation layer between the hot gas flow and the metallic substrate.

The metallic base body is protected against the aggressive hot gas flow by coatings. In this context, modern components usually comprise a plurality of coatings which respectively fulfill specific functions. The system is therefore a multilayer system.

Since the power and efficiency of gas turbines increase with a rising operating temperature, attempts are continually being made to achieve a higher performance of gas turbines by improving the coating system.

EP 0 944 746 B1 discloses the use of pyrochlores as a thermal insulation layer. The use of a material as a thermal insulation layer, however, requires not only good thermal insulation properties but also good bonding to the substrate.

EP 0 992 603 A1 discloses a thermal insulation layer system of gadolinium oxide and zirconium oxide, which is not intended to have a pyrochlore structure.

### SUMMARY OF INVENTION

It is therefore an object of the invention to provide a layer system which has good thermal insulation properties and good bonding to the substrate, and therefore a long lifetime of the entire layer system.

The invention is based on the discovery that in order to achieve a long lifetime, the entire system must be considered as a whole and individual layers or some layers together should not be considered and optimized separately from one another.

The object is achieved by a layer system as claimed in the claims.

The dependent claims describe further advantageous measures, which may advantageously be combined in any desired way.

### BRIEF DESCRIPTION OF THE DRAWINGS

FIG. 1 shows a layer system according to the invention,

FIG. 2 shows a page of superalloys,

FIG. 3 shows a perspective view of a turbine blade,

FIG. 4 shows a perspective view of a combustion chamber,

FIG. 5 shows a gas turbine.

### DETAILED DESCRIPTION OF INVENTION

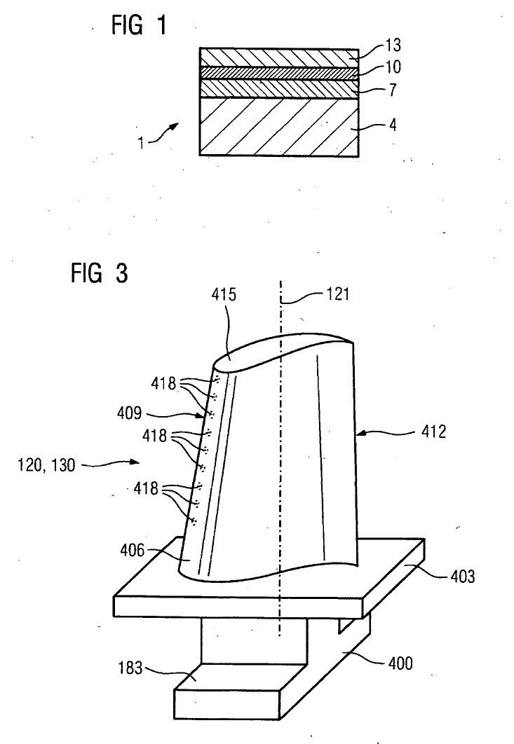

FIG. 1 shows a layer system 1 according to the invention.

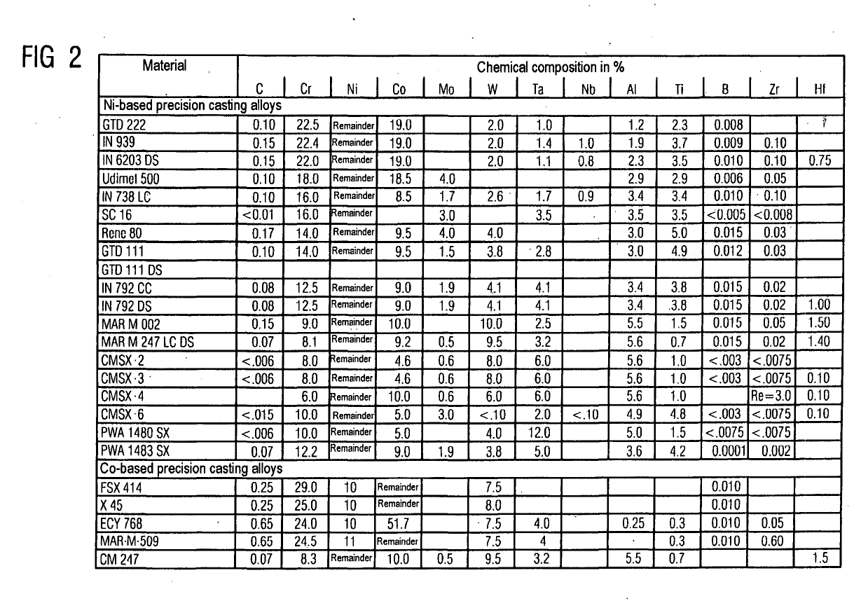

The layer system 1 comprises a metallic substrate 4 which, in particular for components at high temperatures, consists of a nickel- or cobalt-based superalloy (FIG. 2).

Directly on the substrate 4, there is preferably a metallic bonding layer 7 in particular of the NiCoCrAlX type, which preferably consists of

(11-13) wt % cobalt, in particular 12 wt % Co,

(20-22) wt % chromium, in particular 21 wt % Cr,

(10.5-11.5) wt % aluminum, in particular 11 wt % Al,

(0.3-0.5) wt % yttrium, in particular 0.4 wt % Y,

(1.5-2.5) wt % rhenium and in particular 2.0 wt % Re,

and remainder nickel,

or preferably of

(24-26) wt % cobalt, in particular 25 wt % Co,

(16-18) wt % chromium, in particular 17 wt % Cr,

(9.5-10.5) wt % aluminum, in particular 10 wt % Al,

(0.3-0.5) wt % yttrium, in particular 0.4 wt % Y,

−2.0) wt % rhenium and in particular 1.5 wt % Re,

remainder nickel,

or preferably of

29 wt %-31 wt % nickel, in particular 30 wt % nickel,

27 wt %-29 wt % chromium, in particular 28 wt % chromium,

7 wt %-9 wt % aluminum, in particular 8 wt % aluminum,

0.5 wt %-0.7 wt % yttrium, in particular 0.6 wt % yttrium,

0.6 wt %-0.8 wt % silicon, in particular 0.7 wt % silicon, and

remainder cobalt,

or preferably of

27 wt %-29 wt % nickel, in particular 28 wt % nickel,

23 wt %-25 wt % chromium, in particular 24 wt % chromium,

9 wt %-11 wt % aluminum, in particular 10 wt % aluminum,

0.3 wt %-0.7 wt % yttrium, in particular 0.6 wt % yttrium, and

remainder cobalt.

An aluminum oxide layer is preferably formed already on this metallic bonding layer 7 before further ceramic layers are applied, or such an aluminum oxide layer (TGO) is formed during operation.

There is generally an inner ceramic layer 10, preferably a fully or partially stabilized zirconium oxide layer, on the metallic bonding layer 7 or on the aluminum oxide layer (not shown) or on the substrate 4. Yttrium-stabilized zirconium oxide is preferably used, with 6 wt %-8 wt % of yttrium preferably being employed. Calcium oxide, cerium oxide and/or hafnium oxide may likewise be used to stabilize zirconium oxide.

The zirconium oxide is preferably applied as a plasma-sprayed layer, although it may also preferably be applied as a columnar structure by means of electron beam deposition (EBPVD).

An outer ceramic layer 13 which consists mainly of a pyrochlore phase, i.e. it comprises at least 80 wt % of the pyrochlore phase that consists of either Gd₂Hf₂O₇ or Gd₂Zr₂O₇, is applied on the stabilized zirconium oxide layer 10.

Preferably 100 wt % of the outer layer 13 consists of one of the two pyrochlore phases. Amorphous phases, pure GdO₂, pure ZrO₂ or pure HfO₂, mixed phases of GdO₂ and ZrO₂ or HfO₂, which do not comprise the pyrochlore phase, are in this case undesirable and should be minimized.

The layer thickness of the inner layer 10 is preferably between 10% and 50% of the total layer thickness of the inner layer 10 plus the outer layer 13.

The inner ceramic layer 10 preferably has a thickness of from 40 μm to 60 μm, in particular 50 μm±10%

The total layer thickness of the inner layer 10 plus the outer layer 13 is preferably 300 μm or preferably 400 μm. The maximum total layer thickness is advantageously 800 μm or preferably at most 600 μm.

The layer thickness of the inner layer 10 is preferably between 10% and 40% or between 10% and 30% of the total layer thickness.

It is likewise advantageous for the layer thickness of the inner layer 10 to comprise from 10% to 20% of the total layer thickness.

It is likewise preferable for the layer thickness of the inner layer 10 to be between 20% and 50% or between 20% and 40% of the total layer thickness.

Advantageous results are likewise achieved if the contribution of the inner layer 10 to the total layer thickness is between 20% and 30%.

The layer thickness of the inner layer 10 is preferably from 30% to 50% of the total layer thickness.

It is likewise advantageous for the layer thickness of the inner layer 10 to comprise from 30% to 40% of the total layer thickness.

It is likewise preferable for the layer thickness of the inner layer 10 to be between 40% and 50% of the total layer thickness.

Although the pyrochlore phase has better thermal insulation properties than the ZrO₂ layer, the ZrO₂ layer may be configured to be just as thick as the pyrochlore phase.

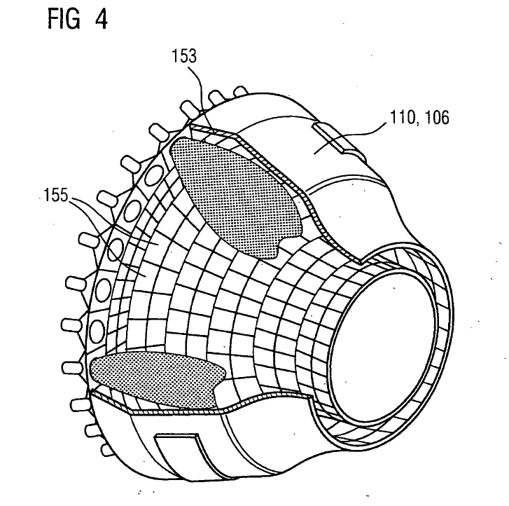

FIG. 3 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening zone 400, a blade platform 403 adjacent thereto as well as a blade surface 406. As a guide vane 130, the vane 130 may have a further platform (not shown) at its vane tip 415.

A blade root 183 which is used to fasten the rotor blades 120, 130 on a shaft or a disk (not shown) is formed in the fastening zone 400.

The blade root 183 is configured, for example, as a hammerhead. Other configurations as a firtree or dovetail root are possible.

The blade 120, 130 comprises a leading edge 409 and a trailing edge 412 for a medium which flows past the blade surface 406.

In conventional blades 120, 130, for example solid metallic materials, in particular superalloys, are used in all regions 400, 403, 406 of the blade 120, 130.

Such superalloys are known for example from EP 1 204 776 B1, EP 1 306 454, EP 1 319 729 A1, WO 99/67435 or WO 00/44949; with respect to the chemical composition of the alloy, these documents are part of the disclosure.

The blades 120, 130 may in this case be manufactured by a casting method, also by means of directional solidification, by a forging method, by a machining method or combinations thereof.

Workpieces with a monocrystalline structure or structures are used as components for machines which are exposed to heavy mechanical, thermal and/or chemical loads during operation.

Such monocrystalline workpieces are manufactured, for example, by directional solidification from the melts. These are casting methods in which the liquid metal alloy is solidified to form a monocrystalline structure, i.e. to form the monocrystalline workpiece, or is directionally solidified.

Dendritic crystals are in this case aligned along the heat flux and form either a rod crystalline grain structure (columnar, i.e. grains which extend over the entire length of the workpiece and in this case, according to general terminology usage, are referred to as directionally solidified) or a monocrystalline structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or monocrystalline component.

When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures.

Such methods are known from U.S. Pat. No. 6,024,792 and EP 0 892 090 A1; these documents are part of the disclosure.

The blades 120, 130 may likewise have coatings against corrosion or oxidation, for example (MCrAlX; M is at least one element from the group ion (Fe), cobalt (Co), nickel (Ni), X is an active element and stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1 which, with respect to the chemical composition of the alloy, are intended to be part of this disclosure.

On the MCrAlX layer, there may furthermore be a ceramic thermal insulation layer 13 according to the invention.

Rod-shaped grains are produced in the thermal insulation layer by suitable coating methods, for example electron beam deposition (EB-PVD).

Refurbishment means that components 120, 130 may need to have protective layers taken off (for example by sandblasting) after their use. Then the corrosion and/or oxidation layers or products are removed. Optionally, cracks in the component 120, 130 are also repaired. The component 120, 130 is then recoated and the component 120, 130 is used again.

The blade 120, 130 may be designed to be a hollow or solid. If the blade 120, 130 is intended to be cooled, it will be hollow and optionally also comprise film cooling holes 418 (indicated by dashes).

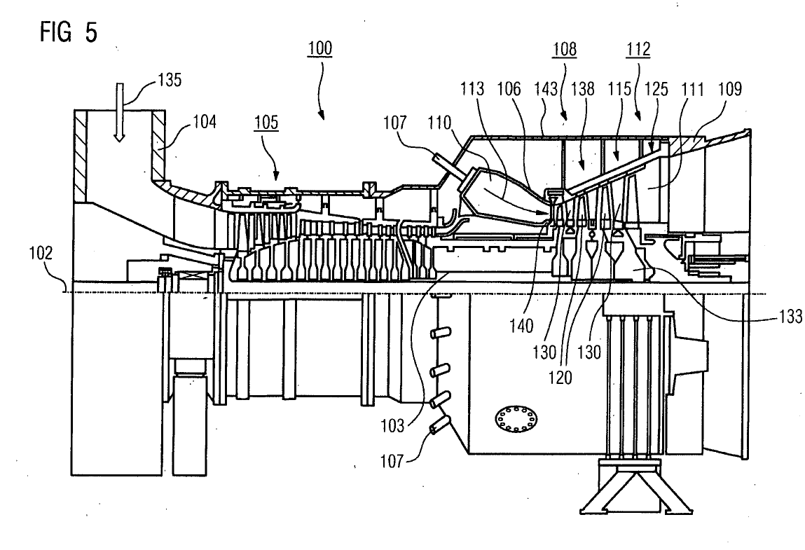

FIG. 4 shows a combustion chamber 110 of a gas turbine 100 (FIG. 5).

The combustion chamber 110 is designed for example as a so-called ring combustion chamber in which a multiplicity of burners 107, which produce flames 156 and are arranged in the circumferential direction around a rotation axis 102, open into a common combustion chamber space 154. To this end, the combustion chamber 110 as a whole is designed as an annular structure which is positioned around the rotation axis 102.

In order to achieve a comparatively high efficiency, the combustion chamber 110 is designed for a relatively high temperature of the working medium M, i.e. about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M.

Each heat shield element 155 made of an alloy is equipped with a particularly heat-resistant protective layer (MCrAlX layer and/or ceramic coating) on the working medium side, or is made of refractory material (solid ceramic blocks).

These protective layers may be similar to the turbine blades, i.e. for example MCrAlX means: M is at least one element from the group ion (Fe), cobalt (Co), nickel (Ni), X is an active element and stands for yttrium (Y) and/or silicon and/or at least one rare earth element, or hafnium (Hf). Such alloys are known from EP 0 486 489 B1, EP 0 786 017 B1, EP 0 412 397 B1 or EP 1 306 454 A1 which, with respect to the chemical composition of the alloy, are intended to be part of this disclosure.

Refurbishment means that heat shield elements 155 may need to have protective layers taken off (for example by sandblasting) after their use. The corrosion and/or oxidation layers or products are then removed. Optionally, cracks in the heat shield element 155 are also repaired. The heat shield elements 155 are then recoated and the heat shield elements 155 are used again.

Owing to the high temperatures inside the combustion chamber 110, a cooling system may also be provided for the heat shield elements 155 or for their retaining elements. The heat shield elements 155 are then hollow, for example, and optionally also have film cooling holes (not shown) opening into the combustion chamber space 154.

FIG. 5 shows a gas turbine 100 by way of example in a partial longitudinal section.

The gas turbine 100 internally comprises a rotor 103, which will also be referred to as the turbine rotor, mounted so as to rotate about a rotation axis 102 and having a shaft 101.

Successively along the rotor 103, there are an intake manifold 104, a compressor 105, an e.g. toroidal combustion chamber 110, in particular a ring combustion chamber, having a plurality of burners 107 arranged coaxially, a turbine 108 and the exhaust manifold 109.

The ring combustion chamber 110 communicates with an e.g. annular hot gas channel 111. There, for example, four successively connected turbine stages 112 form the turbine 108.

Each turbine stage 112 is formed for example by two blade rings. As seen in the flow direction of a working medium 113, a guide vane row 115 is followed in the hot gas channel 111 by a row 125 formed by rotor blades 120.

The guide vanes 130 are fastened on an inner housing 138 of a stator 143 while the rotor blades 120 of a row 125 are fastened on the rotor 103, for example by means of a turbine disk 133. Coupled to the rotor 103, there is a generator or a work engine (not shown).

During operation of the gas turbine 100, air 135 is taken in and compressed by the compressor 105 through the intake manifold 104. The compressed air provided at the turbine-side end of the compressor 105 is delivered to the burners 107 and mixed there with a fuel. The mixture is then burnt to form the working medium 113 in the combustion chamber 110. From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

During operation of the gas turbine 100, the components exposed to the hot working medium 113 experience thermal loads. Apart from the heat shield elements lining the ring combustion chamber 110, the guide vanes 130 and rotor blades 120 of the first turbine stage 112, as seen in the flow direction of the working medium 113, are heated the most.

In order to withstand the temperatures prevailing there, they may be cooled by means of a coolant.

Substrates of the components may likewise comprise a directional structure, i.e. they are monocrystalline (SX structure) or comprise only longitudinally directed grains (DS structure).

Iron-, nickel- or cobalt-based superalloys are for example used as material for the components, in particular for the turbine blades 120, 130 and components of the combustion chamber 110.

Such superalloys are known for example from EP 1 204 776 B1, EP 1 306 454, EP 1 319 729 A1, WO 99/67435 or WO 00/44949; with respect to the chemical composition of the alloy, these documents are part of the disclosure.

The guide vanes 130 comprise a guide vane root (not shown here) facing the inner housing 138 of the turbine 108, and a guide vane head lying opposite the guide vane root. The guide vane head faces the rotor 103 and is fixed on a fastening ring 140 of the stator 143.

1.-21. (canceled)

22. A layer system, comprising
a substrate;
a metallic bonding layer arranged on the substrate which consists of an NiCoCrAlX alloy;
an inner yttrium-stabilized zirconium oxide layer arranged on the metallic bonding layer; and
an outer ceramic layer arranged on the inner ceramic layer comprising at least 80 wt % of a pyrochlore phase, wherein the pyrochlore phase is Gd2Zr2O7 or Gd2Zr2O7.

23. The layer system as claimed in claim 22, wherein the inner layer has a layer thickness between 10% and 50% of a total layer thickness of the inner layer plus the outer layer.

24. The layer system as claimed in claim 22, wherein the inner layer has a layer thickness of between 10% and 40% of the total layer thickness of the inner layer plus the outer layer.

25. The layer system as claimed in claim 22, wherein the inner layer has a layer thickness of between 10% and 30% of the total layer thickness of the inner layer plus the outer layer.

26. The layer system as claimed in claim 22, wherein the inner layer has a layer thickness of between 10% and 20% of the total layer thickness of the inner layer plus the outer layer.

27. The layer system as claimed in claim 22, wherein the inner layer has a layer thickness of between 20% and 50% of the total layer thickness of the inner layer plus the outer layer.

28. The layer system as claimed in claim 22, wherein the inner layer has a layer thickness of between 20% and 40% of the total layer thickness of the inner layer plus the outer layer.

29. The layer system claimed in claim 22, wherein the inner layer has a layer thickness of between 20% and 30% of the total layer thickness of the inner layer plus the outer layer.

30. The layer system as claimed in claim 22, wherein the inner layer has a layer thickness of between 30% and 50% of the total layer thickness of the inner layer plus the outer layer.

31. The layer system as claimed in claim 22, wherein the inner layer has a layer thickness of between 30% and 40% of the total layer thickness of the inner layer plus the outer layer.

32. The layer system as claimed in claim 22, wherein the inner layer has a layer thickness of between 40% and 50% of the total layer thickness of the inner layer plus the outer layer.

33. The layer system as claimed in claim 22, wherein the inner layer (10) has a layer thickness of 40 μm to 60 μm.

34. The layer system as claimed in claim 22, wherein the metallic bonding layer has the composition (in wt %):
11%-13% cobalt,
20%-22% chromium,
10.5%-11.5% aluminum,
0.3%-0.5% yttrium,
1.5%-2.5% rhenium, and
remainder nickel.

35. The layer system as claimed in claim 22, wherein the metallic bonding layer has the composition (in wt %):
24%-26% cobalt,
16%-18% chromium,
9.5%-10.5% aluminum,
0.3%-0.5% yttrium,
1.0%-2.0% rhenium, and
remainder nickel.

36. The layer system as claimed in claim 22, wherein the metallic bonding layer has the composition (in wt %):
29%-31% nickel,
27%-29% chromium,
7%-9% aluminum,
0.5%-0.8% yttrium,
0.6%-0.8% silicon, and
remainder cobalt.

37. The layer system as claimed in claim 22, wherein the metallic bonding layer has the composition (in wt %):
27%-29% nickel,
23%-25% chromium,
9%-11% aluminum,
0.3%-0.7% yttrium, and
remainder cobalt.

38. The layer system as claimed in claim 22, wherein the yttrium-stabilized zirconium oxide layer comprises 6 wt %-8 wt % of yttrium.

39. The layer system as claimed in claim 22, wherein the total layer thickness of the inner layer plus the outer layer is 300 μm.

40. The layer system as claimed in claim 22, wherein the total layer thickness of the inner layer plus the outer layer is 400 μm.

41. The layer system as claimed in claim 22, wherein the total layer thickness is at most 600 μm.
